(19) United States
(12) Patent Application Publication
(10) Pub. No.: US 2011/0102384 A1
(43) Pub. Date: May 5, 2011

(54) DRIVER CHIP

(75) Inventors: YI-JUI HUANG, Xizhi City (TW); Chun-Chieh Yu, Taipei City (TW)

(73) Assignee: CHUNGHW A PICTURE TUBES, LTD., Taoyuan (TW)

(21) Appl. No.: 12/698,466

(22) Filed: Feb. 2, 2010

(30) Foreign Application Priority Data
Oct. 30, 2009 (TW) 098220142

(51) Int. Cl. G09G 5/00

(52) U.S. Cl. 345/204

(57) ABSTRACT

A driver chip is suitable to be mounted on an active device array substrate of a display. The active device array substrate includes a plurality of signal lines. The driver chip includes a chip body, a plurality of output terminals, and a plurality of load adjusting units. The output terminals are used for electrically connecting some of the signal lines, and the load adjusting units are electrically connected between the output terminals and the chip body. The chip body is electrically connected to the plurality of signal lines through the output terminals and the load adjusting units. The load adjusting units are used for enabling loads between the chip body and the signal lines electrically connected to the chip body to be consistent.

### CROSS-REFERENCE TO RELATED APPLICATION

This application claims the benefit of Taiwan Patent Application No. 098220142, filed on Oct. 30, 2009, which is hereby incorporated by reference for all purposes as if fully set forth herein.

### BACKGROUND OF THE INVENTION

1. Field of Invention

The present invention relates to a driver chip, and more particularly to a driver chip used on a display.

2. Related Art

A thin-film transistor (TFT) array substrate is an important element that is indispensable for a liquid crystal display (LCD), and the TFT array substrate generally includes a plurality of pixel units, a plurality of scan lines, and a plurality of data lines.

The pixel units are electrically connected between the scan lines and the data lines, and each of the pixel units generally includes a transistor and a pixel electrode. Each transistor has a gate, a source, and a drain. The gates are connected to the scan lines, the sources are connected to the data lines, and the drains are connected to the pixel electrode.

The LCD further includes a driver chip mounted on the TFT array substrate, and the driver chip is electrically connected to the scan lines and turn the transistors on or off through the scan lines, thereby controlling the data lines to output a voltage to the pixel electrodes, so as to charge liquid crystal capacitors (LC capacitors) corresponding to the pixel units. Thus, liquid crystal molecules in a liquid crystal layer are driven to enable the LCD to display images.

However, every scan line has a different length, resulting in a different resistance, and has a different total capacitance, so that the impedance between each scan line and the driver chip is somewhat different. Thus, the load between the driver chip and each scan line is different. Once the difference becomes excessively large, serious resistance-capacitance delay (RC delay) occurs, which results in the inconsistent charging time for the LC capacitors corresponding to the pixel units. As a result, a picture with non-uniform brightness distribution appears, for example, bright lines and dark lines occur, thereby deteriorating the picture quality of the LCD.

### SUMMARY OF THE INVENTION

The present invention is directed to a driver chip, which is suitable to be mounted on a display, so as to solve the above problem that a picture quality is deteriorated due to RC delay.

The present invention provides a driver chip suitable to be mounted on an active device array substrate of a display. The active device array substrate includes a plurality of signal lines. The driver chip includes a chip body, a plurality of output terminals, and a plurality of load adjusting units. The output terminals are used for electrically connecting some of the signal lines, and the load adjusting units are electrically connected between the output terminals and the chip body. The chip body is electrically connected to the plurality of signal lines through the output terminals and the load adjusting units. The load adjusting units are used for enabling loads between the chip body and the signal lines electrically connected to the chip body to be consistent.

Based on the above, a plurality of load adjusting units included in the driver chip of the present invention enables loads between a chip body and a plurality of signal lines electrically connected to the chip body to be consistent, thereby avoiding serious RC delay and enhancing the picture quality of the display.

To make the above features and advantages of the present invention more comprehensible, the present invention is described below in detail through the embodiments with reference to the accompanying drawings.

### BRIEF DESCRIPTION OF THE DRAWINGS

FIG. 1 is a schematic circuit diagram of a driver chip and a display mounted with the driver chip according to a first embodiment of the present invention; and

FIG. 2 is a schematic circuit diagram of a driver chip and a display mounted with the driver chip according to a second embodiment of the present invention.

### DETAILED DESCRIPTION OF THE INVENTION

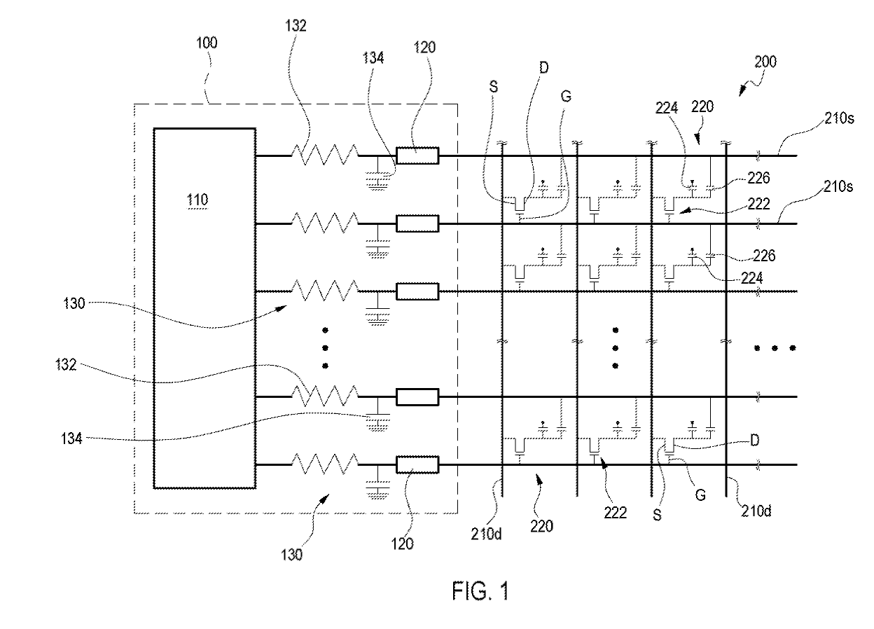

FIG. 1 is a schematic circuit diagram of a driver chip and a display mounted with the driver chip according to a first embodiment of the present invention. Referring to FIG. 1, a driver chip 100 of the embodiment is suitable to be mounted on an active device array substrate 200, and the active device array substrate 200 is an active device array substrate of a display. The display may be an LCD, for example, a liquid crystal screen for a computer, a liquid crystal TV, a liquid crystal screen for a cell phone, or a liquid crystal projector.

The active device array substrate 200 includes a plurality of signal lines 210s, 210d, and a plurality of pixel units 220. The pixel units 220 are electrically connected to the signal lines 210s, 210d. The signal lines 210s, 210d are respectively a plurality of scan lines and a plurality of data lines. The signal lines 210s are scan lines, and the signal lines 210d are data lines. Each of the pixel units 220 includes a transistor 222 and a pixel electrode (not shown). In each of the pixel units 220, the transistor 222 is electrically connected to the pixel electrode and has a gate G, a drain D, and a source S.

The LCD where the active device array substrate 200 is installed generally includes a liquid crystal layer and an opposite substrate (both are not shown). The opposite substrate is, for example, a color filter substrate. The liquid crystal layer is disposed between the opposite substrate and the pixel electrodes. The liquid crystal layer, the opposite substrate, and the pixel electrodes together form a plurality of LC capacitors 224. In each of the pixel units 220, the gate G of the transistor 222 is connected to the signal line 210s, the source S is connected to the signal line 210d, and the drain D is connected to the LC capacitor 224.

Additionally, each of the pixel units 220 may further include a plurality of storage capacitors (Csts) 226 electrically connected to the drain D of the transistor 222. In the embodiment shown in FIG. 1, the Cst 226 is electrically connected to the signal line 210s (that is, the scan line), and the Cst 226 is a Cst on gate. However, in other embodiments, the Cst 226 may be electrically connected to a common line and may be a Cst on common.

The driver chip 100 includes a chip body 110, a plurality of output terminals 120, and a plurality of load adjusting units 130. The load adjusting units 130 are electrically connected between the output terminals 120 and the chip body 110. The output terminals 120 are used for electrically connecting to the signal lines 210s (that is, the scan lines), and the chip body 110 electrically connects to the signal line 210s through the output terminals 120 and the load adjusting units 130.

The function of the chip body 110 is to control the ON/OFF of the transistors 222. The signal lines 210s are connected to the gates G of the transistors 222, so that the chip body 110 turns the transistors 222 on or off through the signal lines 210s, thereby controlling to charge the LC capacitors 224, and enabling the LCD to display images.

The function of the load adjusting units 130 is to enable loads between the chip body 110 and the signal lines 210s electrically connected to the chip body 110 to be consistent. That is to say, the load adjusting units 130 enable the load between each of the signal lines 210s and the chip body 110 to be substantially the same.

Specifically, each of the load adjusting units 130 and the signal lines 210s electrically connected thereto have a total resistance value in common and a common total capacitance value in common. The total resistance values are substantially the same, and the total capacitance values are substantially the same. In other words, each of the load adjusting units 130 may respectively adjust the resistance value and the capacitance value respectively between the signal lines 210s electrically connected to each of the load adjusting units 130 and the chip body 110, thereby enabling the loads between the chip body 110 and the signal lines 210s electrically connected to the chip body 110 to be consistent.

In the embodiment, each of the load adjusting units 130 includes a resistor 132 and a capacitor 134. The capacitor 134 is electrically connected to the resistor 132, and the resistor 132 is electrically connected to the chip body 110 directly. In each of the load adjusting units 130, the resistor 132 is connected to the capacitor 134 in parallel and connected to the signal line 210s in series. The capacitor 134 is connected to the signal line 210s in parallel, as shown in FIG. 1.

In the load adjusting units 130 and the signal lines 210s connecting to the load adjusting units 130, the above total resistance value is a sum of the resistance of the signal line 210s and the resistance of the resistor 132, and the above total capacitance value is a sum of the capacitance of the signal line 210s and the capacitance of the capacitor 134. The capacitance of the signal line 210s refers to a total capacitance of a whole signal line 210s, which is affected by the LC capacitor 224 and the Cst 226. Through the resistor 132 and the capacitor 134, the load adjusting units 130 may adjust the resistance values and the capacitance values between the signal lines 210s and the chip body 110, thereby enabling the loads between the chip body 110 and the signal lines 210s to be consistent.

For example, among all of the signal lines 210s, one signal line 210s has the maximum resistance. The other signal lines 210s take the signal line 210s with the maximum resistance as a reference, and increase the resistance values thereof through the resistors 132, thereby enabling the resistance values between the chip body 110 and the signal lines 210s to be substantially the same.

Similarly, among all of the signal lines 210s, one signal line 210s has a maximum capacitance. The other signal lines 210s take the signal line 210s with the maximum capacitance as a reference, and increase the capacitance values thereof through the capacitors 134, thereby enabling the capacitance values between the chip body 110 and the signal lines 210s to be substantially the same.

It should be noted that, both the maximum resistance and the maximum capacitance of the signal lines 210s may be measured by a measurement machine or may be simulated values obtained from program simulation. In detail, when designing the layout of the active device array substrate 200, the program simulation is performed. The signal lines 210s, 210d are simulated through software, and the resistance value and the capacitance value of each of the signal lines 210s, 210d may be calculated when the actual situation is simulated.

After both the resistance value and the capacitance value of each of the signal lines 210s, 210d are calculated during the actual situation simulated, the maximum resistance value and the maximum capacitance value are found out from the resistance values and the capacitance values of the signal lines 210s. Thus, the signal line 210s with the maximum capacitance value and the signal line 210s with the maximum resistance value are obtained. In this manner, the resistance values and the capacitance values between the signal lines 210s and the chip body 110 can be adjusted through the load adjusting units 130.

Based on the above, the resistance values and the capacitance values between the signal lines 210s and the chip body 110 are able to be adjusted through the load adjusting units 130, so that the resistance values are made to be substantially the same, and the capacitance values are made to be substantially the same. Hence, the load adjusting units 130 are able to enable the loads between the chip body 110 and the signal lines 210s electrically connected to the chip body 110 to be consistent, so as to avoid serious RC delay and enable the charging time for each LC capacitor 224 to be consistent, thereby enhancing the picture quality of the display.

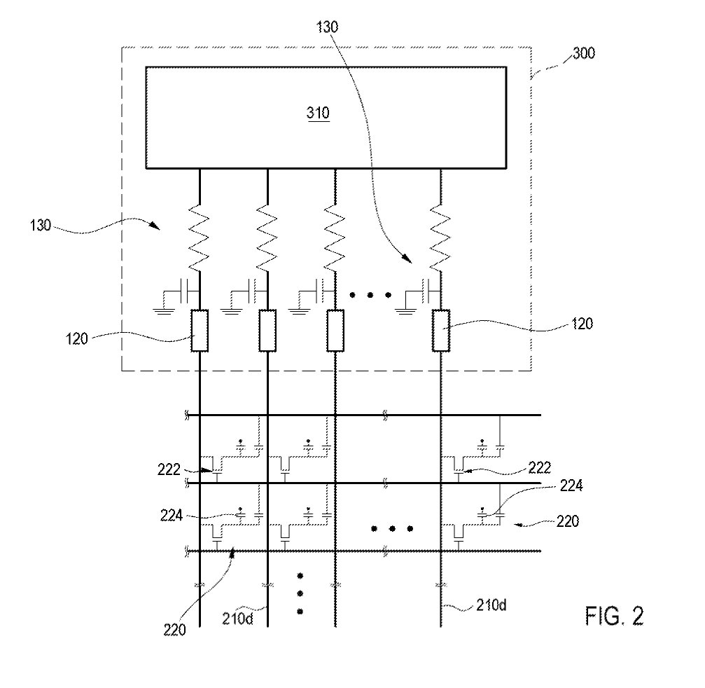

FIG. 2 is a schematic circuit diagram of a driver chip and a display mounted with the driver chip according to a second embodiment of the present invention. Referring to FIG. 2, a driver chip 300 in this embodiment is suitable to be mounted on an active device array substrate 200 and includes a chip body 310, the output terminals 120, and the load adjusting units 130.

The driver chip 300 in the second embodiment is similar to the driver chip 100 in the first embodiment, and the same features thereof are not described herein again. Merely, the differences there-between are introduced as follows. The differences there-between mainly lie in the different functions of the chip body 310 and the chip body 110.

The function of the chip body 310 is to output a pixel voltage to the pixel units 220. In detail, the output terminals 120 are used for electrically connecting the signal lines 210d (that is, data lines), and the chip body 310 is electrically connected to the signal lines 210d through the output terminals 120 and the load adjusting units 130. When the transistor 222 is turned on, the pixel voltage is transmitted to the pixel electrode (not shown) of the pixel unit 220 from the signal line 210d (that is, the data line), thereby charging the LC capacitor 224 and facilitating the LCD to display images.

The functions of the load adjusting units 130 are similar to that in the above embodiment. Specifically, the load adjusting units 130 enable the loads between the chip body 310 and the signal lines 210d electrically connected to the chip body 310 to be consistent. That is to say, the load adjusting units 130 can enable the load between each of the signal lines 210d and the chip body 310 to be substantially the same, and the means and principle for enabling the loads between the chip body 310 and the signal lines 210d to be consistent are the same as that mentioned in the first embodiment, so that the details thereof may not be described herein again.

In view of above, a plurality of load adjusting units included in the driver chip of the present invention enable the loads between the chip body and a plurality of signal lines electrically connected to the chip body to be consistent, and the signal lines may be a plurality of scan lines or a plurality of data lines. Thus, the present invention can avoid serious RC delay, reduce the pictures with significant non-uniform brightness distribution, and enable the charging time for each LC capacitor to be consistent, thereby enhancing the picture quality of the display.

The embodiments of the present invention have been described above, but not intended to restrict the present invention. The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A driver chip, suitable to be mounted on an active device array substrate of a display, wherein the active device array substrate comprises a plurality of signal lines, the driver chip comprising:
a chip body;
a plurality of output terminals, using for electrically connecting some of the signal lines; and
a plurality of load adjusting units, electrically connected between the output terminals and the chip body, wherein the chip body is electrically connected to the at least two signal lines through the output terminals and the load adjusting units, and the load adjusting units are used for enabling loads between the chip body and the signal lines electrically connected to the chip body to be consistent.

2. The driver chip according to claim 1, wherein each of the load adjusting units and the signal lines electrically connected thereto have a total resistance value in common and a common total capacitance value in common, the total resistance values are substantially the same, and the total capacitance values are substantially the same.

3. The driver chip according to claim 1, wherein each of the load adjusting units comprises a resistor and a capacitor electrically connected to the resistor, and the resistors are electrically connected to the chip body directly.

4. The driver chip according to claim 3, wherein in each of the load adjusting units, the capacitor is connected to the resistor in parallel.

5. The driver chip according to claim 1, wherein the signal lines are respectively a plurality of scan lines and a plurality of data lines.

6. The driver chip according to claim 5, wherein the output terminals are used for electrically connecting the scan lines.

7. The driver chip according to claim 5, wherein the output terminals are used for electrically connecting the data lines.

8. The driver chip according to claim 1, wherein the display is a liquid crystal display (LCD).
